(19) United States
(12) Patent Application Publication
(10) Pub. No.: US 2012/0167594 A1
(43) Pub. Date: Jul. 5, 2012

(54) Bypass Monitor for Fuel Supply System

(75) Inventors: Richard A. Poisson, Avon, CT (US); Steven A. Heitz, Rockford, IL (US)

(73) Assignee: HAMILTON SUNDSTRAND CORPORATION, Windsor Locks, CT (US)

(21) Appl. No.: 12/984,779

(22) Filed: Jan. 5, 2011

(51) Int. Cl. F02C 6/00; G01M 3/28

(52) U.S. Cl. 60/803; 73/40.5 R

(57) ABSTRACT

A method for monitoring a fuel supply system for a turbine engine, the fuel supply system comprising a fuel pump and a pressure regulation valve configured to receive fuel from an outlet of the fuel pump includes determining by a bypass monitor an amount of bypass flow in a bypass path located between the pressure regulation valve and an inlet of the fuel pump; determining an amount of leakage flow in the fuel supply system by the bypass monitor based on the bypass flow; and determining whether the leakage flow exceeds a predetermined threshold by the bypass monitor, and in the event the leakage flow exceeds the predetermined threshold, indicating a need for maintenance of the fuel supply system.

### FIELD OF INVENTION

The subject matter disclosed herein relates generally to the field of fuel supply systems, and more specifically to a bypass monitor for monitoring the health of a fuel pump in a fuel supply system.

### DESCRIPTION OF RELATED ART

Fuel supply systems for aircraft gas turbine engines may include a fixed positive displacement pump, such as a vane or gear pump, to pressurize fuel for subsequent delivery to the engine. The fuel pump provides a low flow during engine low speed engine starting conditions with a fuel volume that is a function of the speed at which the pump is rotating. The relation of the change in volumetric output for a change in fuel pump speed is linear in nature.

The demand for fuel increases as the engine speed increases, although when measured as a function of the percentage of fuel pump output, demand for fuel is greatest at either low speeds (engine start) or high speeds (takeoff). Therefore, in order to provide the desired flow of fuel to the turbine engine during normal flight operation, the excess fuel output from the fuel pump must be bypassed from the fuel control back to the input of the fuel pump or to a fuel reservoir.

The fuel pump must be sized to ensure an excess flow capacity at all possible operating conditions. Therefore, the fuel pump must be sized for either low speed start conditions or high speed takeoff conditions. The speed for greatest fuel demand is unique to each engine and is a function of the maximum starting speed. For engine applications where the fuel pump has been sized based on start speed, there will be an excess amount of fuel available to the turbine engine at higher speeds.

The fuel supply system for an aircraft may control the flow of fuel to the turbine engine through the use of a metering valve in conjunction with a pressure regulating valve. Operation of the metering valve and the pressure regulating valve is based on incompressible flow theory, which states that flow through a valve is a function of the area of the valve opening multiplied by the square root of the product of the pressure drop across the valve multiplied by the specific gravity of the fluid. The pressure regulating valve controls the pressure drop across the metering valve. As stated above, the fuel pump is sized to provide excess fuel flow for all engine operating conditions. The excess fuel flow is bypassed from the metering valve inlet by the pressure regulating valve back to the pump inlet. To achieve a desired increase in engine speed, an electronic controller may increase the area of the metering valve window to set a desired flow of fuel to the engine. As the metering valve window increases, the flow of fuel to the engine increases and the amount of fuel bypassed by the pressure regulating valve decreases. As the flow of fuel to the engine increases, the speed of the engine will increase, which in turn drives the positive displacement pump at an increased speed. The increase in fuel pump speed increases the flow of fuel which will cause a rise in the pressure differential across the metering valve. The pressure regulating valve will then bypass a portion of the excess fuel output from the fuel pump to maintain the desired pressure differential across the metering valve.

In addition to the fuel required by the engine, the fuel pump also provides a fuel flow having a minimum pressure which is a function of the fuel supply system hardware. The pressurized fuel is used as a working fluid to position valves within the fuel control. Therefore, the fuel must be maintained at sufficient pressure to position the valves (force margin) and furthermore must have sufficient pressure to actuate the valves within a required response time. These fuel system pressures may cause internal leakage of fuel system components, which may reduce the volumetric efficiency and capacity of the fuel pump over time. This loss of fuel pump capacity over time may lead to a failure to start the turbine engine, or a failure to reach maximum thrust on take off.

### BRIEF SUMMARY

According to one aspect of the invention, a method for monitoring a fuel supply system for a turbine engine, the fuel supply system comprising a fuel pump and a pressure regulation valve configured to receive fuel from an outlet of the fuel pump includes determining by a bypass monitor an amount of bypass flow in a bypass path located between the pressure regulation valve and an inlet of the fuel pump; determining an amount of leakage flow in the fuel supply system by the bypass monitor based on the bypass flow; and determining whether the leakage flow exceeds a predetermined threshold by the bypass monitor, and in the event the leakage flow exceeds the predetermined threshold, indicating a need for maintenance of the fuel supply system.

According to another aspect of the invention, a fuel supply system for a turbine engine includes a fuel pump; a pressure regulation valve configured to receive fuel from an outlet of the fuel pump; a bypass path located between the pressure regulation valve and an inlet of the fuel pump; and a bypass monitor configured to: determine an amount of bypass flow in the bypass path; determine an amount of leakage flow in the fuel supply system based on the bypass flow; and determine whether the leakage flow exceeds a predetermined threshold, and in the event the leakage flow exceeds the predetermined threshold, indicate a need for maintenance of the fuel supply system.

Other aspects, features, and techniques of the invention will become more apparent from the following description taken in conjunction with the drawings.

### BRIEF DESCRIPTION OF THE SEVERAL VIEWS OF THE DRAWINGS

Referring now to the drawings wherein like elements are numbered alike in the several FIGURES:

FIG. 1 illustrates an embodiment of a fuel supply system with a bypass monitor.

FIG. 2 illustrates an embodiment of a fuel supply system with a bypass monitor including a bypass pressure monitor.

FIG. 3 illustrates an embodiment of a fuel supply system with a bypass monitor including a bypass flow monitor.

FIG. 4 illustrates a method of monitoring a fuel pump using a bypass monitor.

FIG. 5 illustrates an embodiment of a computer that may be used in conjunction with methods of monitoring a fuel supply system using a bypass monitor.

### DETAILED DESCRIPTION

Embodiments of a bypass flow monitor for a fuel supply system and methods of monitoring fuel supply system health using a bypass flow monitor are provided, with exemplary embodiments being discussed below in detail. Fuel pumps for jet turbine engines are designed to have extra capacity that is above what the turbine engine requires for operation at any given operating point. The excess flow is referred to as bypass flow. There is a third flow component called leakage flow. As the pump wears over time, the bypass flow decreases as leakage flow increases, and pump efficiency degrades. Therefore, a change in the amount of bypass flow in the fuel supply system may be used to detect increased leakage in the fuel supply system. The increased leakage indicates a loss of performance margin in the fuel supply system.

The monitoring of bypass flow may occur at different points in the pump operating range to diagnose the type of degradation that is occurring. Early detection of excessive wear or impending failure of the fuel pump may be indicated by the change in bypass flow. A bypass flow signal may be generated that is proportional to the amount of bypass flow in some embodiments. The fuel pump efficiency may be calculated based on the bypass flow, as the amount of fuel being used by the turbine engine (referred to as the burn flow) is known. The bypass flow signal may be provided at engine start to indicate the start flow margin based on the capacity of the pump. The amount of bypass flow is then used to determine leakage in the fuel supply system. The fuel pump performance margins provided by the bypass monitor at engine start and take off may be used to determine appropriate maintenance intervals for the fuel supply system. Flight delay and/or cancellation may therefore be avoided by scheduling pump maintenance or overhaul before a loss of the minimum required pump capacity occurs.

In addition to the minimum pressure set by the fuel supply system hardware, the engine establishes a backpressure in the fuel nozzles which may increase over time due to fuel deposits. This change in backpressure is significant at maximum flow take off condition and relatively insignificant at engine start. Additional flow is required at take off condition as the engine efficiency degrades due to wear of the engine turbo machinery. Trending data supplied by the bypass monitor can be used to monitor engine performance since bypass flows will exhibit different characteristics if the change in bypass flow is due to pump wear or loss of engine performance.

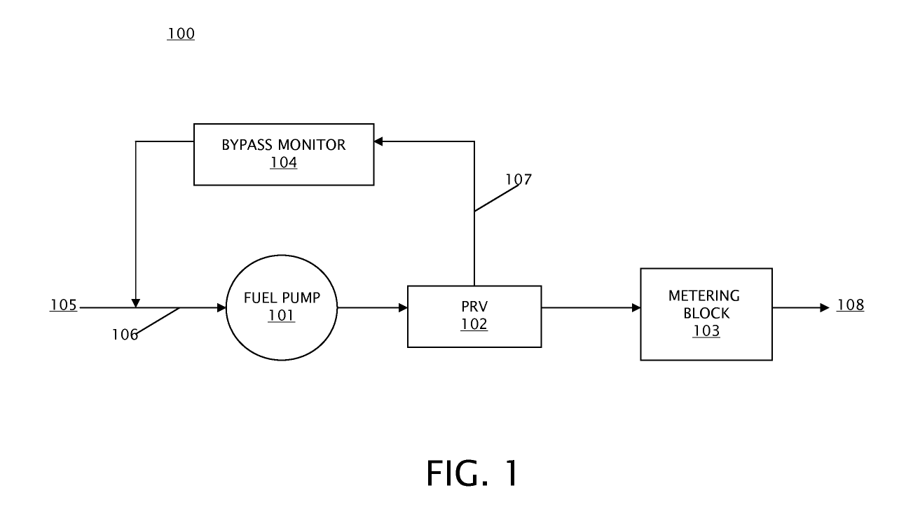

FIG. 1 illustrates an embodiment of a fuel supply system 100 with a bypass monitor 104. Fuel supply system 100 may be an aircraft engine fuel supply system. Fuel is input to the fuel supply system 100 at fuel input 105 to input path 106. Fuel pump 101 receives fuel from input path 106, and propels the fuel to pressure regulation valve 102. Pressure regulations valve (PRV) 102 regulates the amount of fuel that continues to metering valve 103 and output 108, which is connected to the turbine engine (not shown). The amount of fuel sent through output 108 to the turbine engine is referred to as the burn flow. Any fuel received from fuel pump 101 by PRV 102 that exceeds the burn flow required by the turbine engine is routed by PRV 102 to bypass path 107, which routes the excess fuel (i.e., the bypass flow) back to the input path 106.

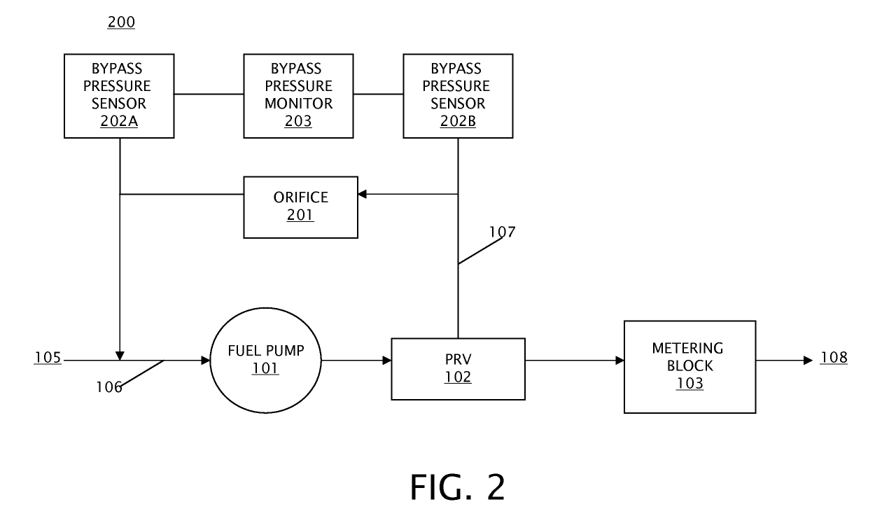

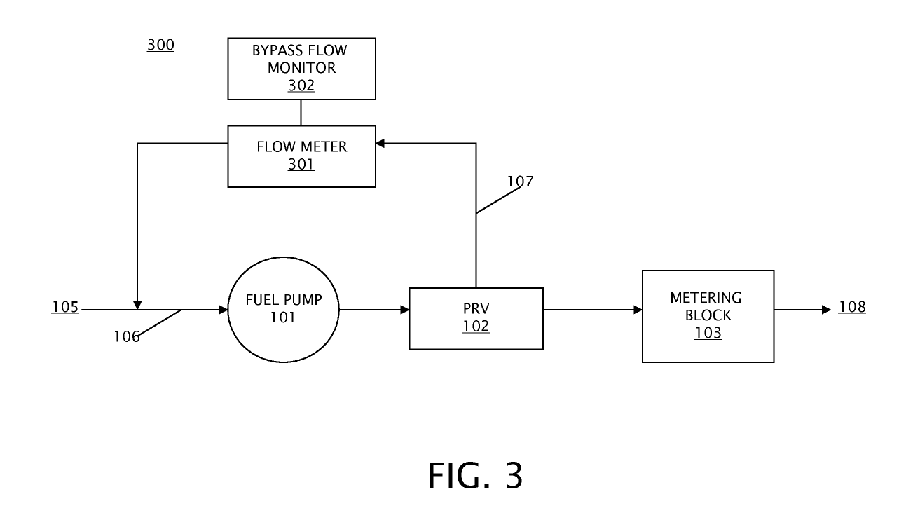

Bypass monitor 104 determines the amount of the bypass flow, i.e., the amount fuel routed through bypass path 107 by PRV 102. The amount of bypass flow may be determined at engine start or take off in some embodiments. The bypass monitor 104 may generate a signal that is proportional to the amount of bypass flow in some embodiments. The bypass flow may be determined by any appropriate method; specific illustrative embodiments of a bypass monitor 104 are discussed below with respect to FIGS. 2-3.

An amount of leakage flow in the fuel supply system 100 is then determined from the amount of bypass flow based on the amount of burn flow, as the burn flow is a known quantity for the turbine engine attached to fuel supply system 100. As the bypass flow decreases, an increase in the amount of leakage flow in fuel supply system 100 is indicated. The bypass monitor 104 may then determine based on the determined amount of leakage flow whether the fuel supply system 100 (in particular fuel pump 101) requires maintenance. This determination may be based on whether the leakage flow exceeds a predetermined threshold. In order to determine an appropriate predetermined threshold, bypass monitor 104 may collect data over time regarding the amount of bypass and leakage flow in fuel supply system 100, and compare the collected bypass and leakage flow data to the current amount of bypass flow and leakage. The data may correspond to particular points in time in the operation of the fuel supply system, such as engine start or take off. If the leakage flow exceeds a predetermined threshold at, for example, takeoff, as compared to previous takeoff leakage measurements, fuel supply system 100 requires maintenance. A signal indicating a need for maintenance of fuel supply system 100 may be triggered. In some embodiments, the signal may be an electrical signal to a visible fuel supply system maintenance indicator.

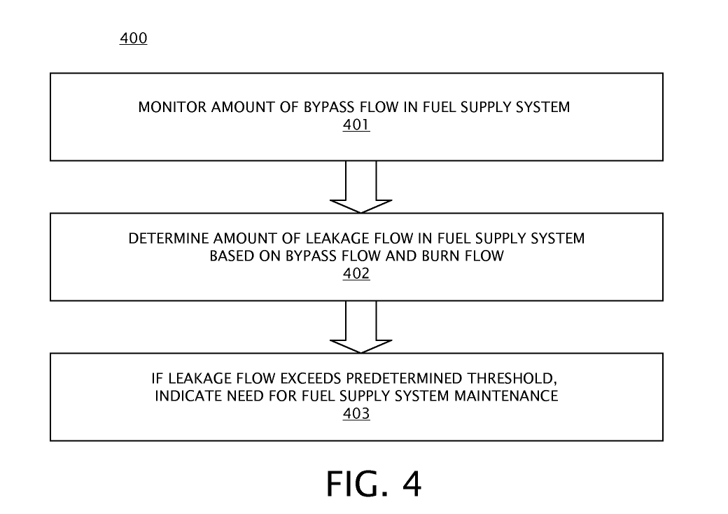

FIG. 2 illustrates an embodiment of a fuel supply system 200 in which the bypass monitor (which may be bypass monitor 104 of FIG. 1) is a pressure monitor including orifice 201, bypass pressure sensors 202A-B, and bypass pressure monitor 203. Orifice 201 acts to induce a pressure drop from bypass path 107 across orifice 201 to input path 106. The orifice 201 may be of a fixed or variable orifice design in various embodiments. Bypass pressure sensor 202B measures the pressure at bypass path 107, and bypass pressure sensor 202A measures the pressure at input path 106. Bypass pressure monitor 203 receives pressure data from bypass pressure sensors 202A-B to determine the differential between the pressure at bypass path 107 and input path 106 across orifice 201 to determine an amount of bypass flow being routed through the bypass path 107 by PRV 102. The determination of the amount of bypass flow is then used by bypass pressure monitor 203 to determine the presence of leakage flow in fuel supply system 200, and to determine whether maintenance of fuel supply system 200 is required, as is discussed above with respect to bypass monitor 104 of FIG. 1 and below with respect to FIG. 4.

FIG. 3 illustrates an embodiment of a fuel supply system 300 in which the bypass monitor (which may be bypass monitor 104 of FIG. 1) is a flow meter 301 and a bypass flow monitor 302. Flow meter 301 determines an amount of fuel flowing through bypass path 107 to input path 106. The flow meter 301 may rotate as the bypass flow passes through the flow meter 301. The speed of the rotation of the flow meter 301 is proportional to the amount of the bypass flow, and may be used to determine the amount of bypass flow by bypass flow monitor 302. The determination of the amount of bypass flow is then used by bypass flow monitor 302 to determine the presence of leakage in fuel supply system 300, and determine whether maintenance of fuel supply system 300 is required, as is discussed above with respect to bypass monitor 104 of FIG. 1 and below with respect to FIG. 4.

FIG. 4 illustrates a method 400 of monitoring a fuel supply system using a bypass monitor. The method 400 may be implemented in bypass monitor 104, which may be embodied as a bypass pressure monitor 203 or a bypass flow meter 301 in various embodiments. In block 401, an amount of bypass flow in a fuel supply system is determined by the bypass monitor. Determination of the amount of bypass flow may be performed using pressure sensors or a flow meter in various embodiments. In block 402, an amount of leakage flow in the fuel supply system is determined based on the amount of bypass flow. The leakage flow is determined using the amount of burn flow, which is known. In block 403, if the amount of leakage flow determined in block 402 exceeds a predetermined threshold, a need for fuel system maintenance is indicated. This determination may be based on whether the leakage flow exceeds a predetermined threshold. In order to determine an appropriate predetermined threshold, the bypass monitor may collect data over time regarding the amount of bypass and leakage flow in the fuel supply system, and compare the collected bypass and leakage flow data to the current amount of bypass flow and leakage. The data may correspond to particular points in time in the operation of the fuel supply system, such as engine start or take off. If the leakage flow exceeds a predetermined threshold at, for example, takeoff, as compared to previous takeoff leakage measurements, fuel supply system requires maintenance. Trending bypass flow at start up and take off may also be used to determine the overall engine health by determining if loss of bypass flow at take off is due to loss of pump capacity (pump wear) or to changes in performance in the engine.

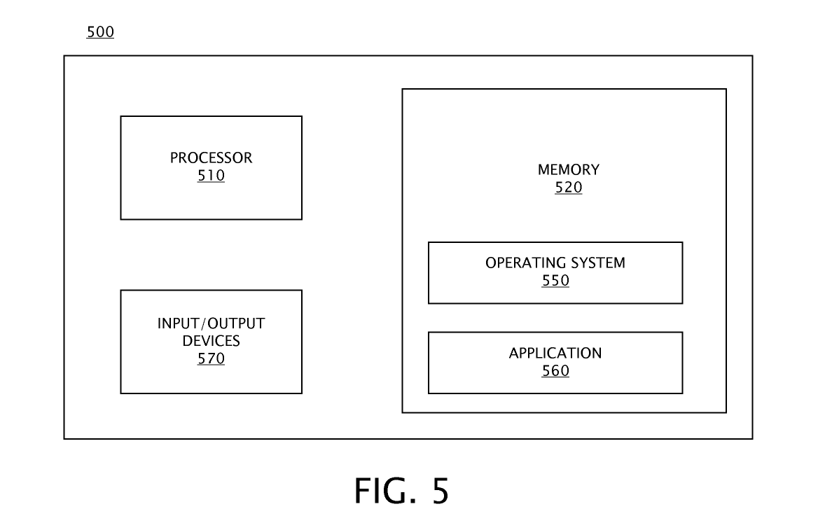

FIG. 5 illustrates an example of a computer 500 which may be utilized by exemplary embodiments of methods of monitoring fuel pump health using a bypass flow monitor as embodied in software. Various operations discussed above may utilize the capabilities of the computer 500. One or more of the capabilities of the computer 500 may be incorporated in any element, module, application, and/or component discussed herein, including the bypass monitor 104, the bypass pressure monitor 203, and the bypass flow monitor 301.

Generally, in terms of hardware architecture, the computer 500 may include one or more processors 510, memory 520, and one or more input and/or output (I/O) devices 570 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 510 is a hardware device for executing software that can be stored in the memory 520. The processor 510 can be virtually any custom made or commercially available processor, a central processing unit (CPU), a digital signal processor (DSP), or an auxiliary processor among several processors associated with the computer 500, and the processor 510 may be a semiconductor based microprocessor (in the form of a microchip) or a macroprocessor.

The memory 520 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 520 may incorporate electronic, magnetic, optical, and/or other types of storage media. Note that the memory 520 can have a distributed architecture, where various components are situated remote from one another, but can be accessed by the processor 510.

The software in the memory 520 may include one or more separate programs, each of which comprises an ordered listing of executable instructions for implementing logical functions. The memory 520 can also store data, such as bypass and leakage flow data. The software in the memory 520 includes a suitable operating system (O/S) 550, and one or more applications 560 in accordance with exemplary embodiments. As illustrated, the application 560 comprises numerous functional components for implementing the features and operations of the exemplary embodiments. The application 560 of the computer 500 may represent various applications, computational units, logic, functional units, processes, operations, virtual entities, and/or modules in accordance with exemplary embodiments, but the application 560 is not meant to be a limitation.

The operating system 550 controls the execution of computer programs, and provides scheduling, input-output control, file and data management, memory management, and communication control and related services. It is contemplated by the inventors that the application 560 for implementing exemplary embodiments may be applicable on all commercially available operating systems.

Application 560 may be a source program, executable program (object code), script, or any other entity comprising a set of instructions to be performed. When a source program, then the program is usually translated via a compiler, assembler, interpreter, or the like, which may or may not be included within the memory 520, so as to operate properly in connection with the O/S 550. Furthermore, the application 560 can be written as an object oriented programming language, which has classes of data and methods, or a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices 570 may include input and output devices to monitor and/or control fuel system components and/or other components of a turbine engine, such as various sensors and actuators. The I/O devices 570 may further include devices that communicate both inputs and outputs, for instance but not limited to, a NIC or modulator/demodulator (for accessing remote devices, other files, devices, systems, or a network), a radio frequency (RF) or other transceiver, a bridge, a router, etc. The I/O devices 570 also include components for communicating over various networks.

When the computer 500 is in operation, the processor 510 is configured to execute software stored within the memory 520, to communicate data to and from the memory 520, and to generally control operations of the computer 500 pursuant to the software. The application 560 and the O/S 550 are read, in whole or in part, by the processor 510, perhaps buffered within the processor 510, and then executed.

When the application 560 is implemented in software it should be noted that the application 560 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 560 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium may include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 560 is implemented in hardware, the application 560 can be implemented with any one or a combination of the following technologies, which are well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The technical effects and benefits of exemplary embodiments include early indication of needed maintenance for a fuel pump in a fuel supply system.

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while various embodiment of the invention have been described, it is to be understood that aspects of the invention may include only some of the described embodiments. Accordingly, the invention is not to be seen as limited by the foregoing description, but is only limited by the scope of the appended claims.

1. A method for monitoring a fuel supply system for a turbine engine, the fuel supply system comprising a fuel pump and a pressure regulation valve configured to receive fuel from an outlet of the fuel pump, the method comprising:
determining by a bypass monitor an amount of bypass flow in a bypass path located between the pressure regulation valve and an inlet of the fuel pump;
determining an amount of leakage flow in the fuel supply system by the bypass monitor based on the bypass flow; and
determining whether the leakage flow exceeds a predetermined threshold by the bypass monitor, and in the event the leakage flow exceeds the predetermined threshold, indicating a need for maintenance of the fuel supply system.

2. The method of claim 1, wherein the bypass monitor comprises a bypass pressure monitor.

3. The method of claim 2, wherein the bypass pressure monitor comprises an orifice in the bypass path, a first pressure sensor located between the pressure regulation valve and the orifice in the bypass path, and a second pressure sensor located between the orifice and the inlet of the fuel pump in the bypass path.

4. The method of claim 3, wherein the amount of bypass flow is determined based on a differential between data from the first pressure sensor and data from the second pressure sensor.

5. The method of claim 1, wherein the bypass monitor comprises a flow meter.

6. The method of claim 5, wherein the amount of bypass flow is determined based on a rotational speed of the flow meter.

7. The method of claim 1, wherein the bypass monitor is configured to collect data regarding the amount of bypass flow in the fuel supply system.

8. The method of claim 7, wherein the bypass monitor is further configured to compare a current amount of determined bypass flow in the fuel supply system with the collected data to determine the amount of leakage flow.

9. The method of claim 8, wherein the current amount of determined bypass flow is determined at one of turbine engine start and takeoff.

10. The method of claim 1, wherein the fuel supply system comprises a fuel supply system for an aircraft.

11. The method of claim 1, further comprising determining if a change in bypass flow at start up or take off is a result of pump wear or of a change in the turbine engine.

12. A fuel supply system for a turbine engine, comprising:
a fuel pump;
a pressure regulation valve configured to receive fuel from an outlet of the fuel pump;
a bypass path located between the pressure regulation valve and an inlet of the fuel pump; and
a bypass monitor configured to:
determine an amount of bypass flow in the bypass path;
determine an amount of leakage flow in the fuel supply system based on the bypass flow; and
determine whether the leakage flow exceeds a predetermined threshold, and in the event the leakage flow exceeds the predetermined threshold, indicate a need for maintenance of the fuel supply system.

13. The fuel supply system of claim 12, wherein the bypass monitor comprises a bypass pressure monitor.

14. The fuel supply system of claim 13, wherein the bypass pressure monitor comprises an orifice in the bypass path, a first pressure sensor located between the pressure regulation valve and the orifice in the bypass path, and a second pressure sensor located between the orifice and the inlet of the fuel pump in the bypass path.

15. The fuel supply system of claim 14, wherein the bypass monitor is configured to determine the amount of bypass flow based on a differential between data from the first pressure sensor and data from the second pressure sensor.

16. The fuel supply system of claim 12, wherein the bypass monitor comprises a flow meter.

17. The fuel supply system of claim 16, wherein the bypass monitor is configured to determine the amount of bypass flow based on a rotational speed of the flow meter.

18. The fuel supply system of claim 12, wherein the bypass monitor is configured to collect data regarding the amount of bypass flow in the fuel supply system.

19. The fuel supply system of claim 18, wherein the bypass monitor is further configured to compare a current amount of determined bypass flow in the fuel supply system with the collected data to determine the amount of leakage flow.

20. The fuel supply system of claim 18, wherein the current amount of determined bypass flow is determined at one of turbine engine start and takeoff.
